(19) United States
(12) Patent Application Publication
(10) Pub. No.: US 2005/0286187 A1
(43) Pub. Date: Dec. 29, 2005

(54) ESD PREVENTING-ABLE LEVEL SHIFTERS

(76) Inventors: Jeng-Shu Liu, Hsinchu County (TW); Shyy-Cheng Liao, Hsinchu City (TW); Chyh-Yih Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,571

(22) Filed: Sep. 25, 2004

(30) Foreign Application Priority Data
Jun. 24, 2004 (TW) 93118236

(51) Int. Cl. H02H 9/00

(52) U.S. Cl. 361/56

(57) ABSTRACT

ESD preventing-able level shifter, for receiving a first signal and outputting a second signal is provided. The level shifter comprises an inverter, a voltage converter, a first ESD clamp circuit and a second ESD clamp circuit. The inverter receives the first signal and outputs a first reverse signal. The voltage converter having a first input terminal for receiving the first reverse signal, a second input terminal for receiving the first signal and an output terminal for outputting the second signal. A first and second terminal of the first ESD clamp circuit is coupled to the first input terminal of the voltage converter and a second ground voltage, respectively. A first and a second terminal of the second ESD clamp circuit is coupled to the second input terminal of the voltage converter and the second ground voltage, respectively.

### CROSS-REFERENCE TO RELATED APPLICATION

This application claims the priority benefit of Taiwan application serial no. 93118236, filed Jun. 24, 2004.

### BACKGROUND OF THE INVENTION

1. Field of the Invention

The present invention relates to an electrostatic discharge (ESD) protection circuit, and more particularly to ESD protection circuit of level shifters.

2. Description of the Related Art

Mixed-voltage integrated circuits apply system voltages with different voltage levels to internal circuits. FIG. 1A is a partial circuit block diagram of a prior art mixed-voltage integrated circuit. The operating voltages of the internal circuit 110 comprises the system voltage VDD1, e.g. 3.3 V, and the ground voltage VSS1, e.g. 0 V. The operating voltages of the internal circuit 130 comprises the system voltage VDD2, e.g. 12 V, and the ground voltage VSS2, e.g. 0 V. The logic level of the internal circuit 110 does not match that of the internal circuit 130. A level shifter 110 is required and serves as an interface of these circuits. For example, the level shifter 120 receives the signal 111 output from the internal circuit 110, transforms the signal 111, e.g. 3.3 V. into a corresponding signal 131 and outputs the signal 131 to the internal circuit 130, e.g. 12 V.

When ESD occurs at a terminal of the mixed-voltage integrated circuit, the ESD current flows along a low impedance path. Due to the ESD current, the devices on such a path will be damaged. FIG. 1B is a drawing showing the ESD paths of the level shifter 120 shown in FIG. 1A. Referring to FIG. 1B, when ESD occurs at the ground voltage VSS2 and the system voltage VDD1 is grounded, the ESD current flows from the ground voltage VSS2 to the system voltage VDD1 through the gate capacitor of the transistor 121, i.e. the dot line ESD1. When the ground voltage VSS1 is grounded, the ESD current flows from the ground voltage VSS2 to the ground voltage VSS1 through the gate capacitor of the transistor 121, i.e. the dot line ESD2. Accordingly, the transistors 121 and 122 may be damaged.

The damage on the devices is caused due to the fact that the ground voltage VSS1 and the ground voltage VSS2 are not coupled to each other. The ESD current cannot reach the ground voltage VSS2 through the ground voltage VSS1, but through the silicon bulk. Due to the low impedance of the silicon bulk, the ESD current damages the transistor 121. Because of the short period of time of the ESD pulse, the impedance of the gate capacitor under ESD operation is lower than the impedance under normal operation.

FIG. 1C is a drawing showing another ESD path of the level shifter 120 shown in FIG. 1A. Referring to FIG. 1C, the ESD damage becomes more serious when ESD occurs at the system voltage VDD2, rather than on the ground voltage VSS2. This phenomenon is observed due to no discharge path existing in the N-well when ESD occurs at the system voltage VDD2. To the contrary, a discharge path can be implemented by connecting the ground voltage VSS1 and the ground voltage VSS2 through the silicon bulk. When ESD occurs at the system voltage VDD2, and because the system voltage VDD1 is grounded, the ESD current flows from the system voltage VDD2 to the system voltage VDD1 through the gate capacitor of the transistor 123, i.e. the path of ESD1. When the ground voltage VSS1 is grounded, the ESD current flows from the system voltage VDD2 to the ground voltage VSS1 through the gate capacitor of the transistor 123, i.e. the path of ESD2. Accordingly, the transistors 123 and 124 may be damaged.

### SUMMARY OF THE INVENTION

Accordingly, the present invention is directed to a electrostatic discharge (ESD) preventing-able level shifter capable of preventing an ESD current flowing from a set of power terminals to another set of power terminals and thereby reducing damage to the level shifter.

The present invention is directed to another ESD preventing-able level shifter capable of providing other ESD route for discharging charges so as to protect the level shifter from damage.

The present invention is directed to the a ESD preventing-able level shifter capable of providing another ESD route between sets of power terminals so as to protect the level shifter from damage.

The present invention discloses a ESD preventing-able level shifter for receiving a first signal and outputting a second signal with a level corresponding to a level of the first signal. The first signal is transmitted between a first system voltage and a first ground voltage, and the second signal is transmitted between a second system voltage and a second ground voltage. The level shifter comprises an inverter, a voltage converter, a first ESD clamp circuit and a second ESD clamp circuit. The inverter receives the first signal and outputs a first reverse signal, wherein the first reverse signal is reverse with respect to the first signal and is transmitted between the first system voltage and the first ground voltage. A first input terminal of the voltage converter receives the first reverse signal. A second input terminal of the voltage converter receives the first signal. An output terminal of the voltage converter outputs the second signal. A first terminal of the first ESD clamp circuit is coupled to the first input terminal of the voltage converter. A second terminal of the first ESD clamp circuit is coupled to the second ground voltage. A first terminal of the second ESD clamp circuit is coupled to the second input terminal of the voltage converter. A second terminal of the second ESD clamp circuit is coupled to the second ground voltage.

The present invention discloses another ESD preventing-able level shifter for receiving a first signal and outputting a second signal with a level corresponding to a level of the first signal. The first signal is transmitted between a first system voltage and a first ground voltage, and the second signal is transmitted between a second system voltage and a second ground voltage. The level shifter comprises an inverter, a voltage converter, a first ESD clamp circuit and a second ESD clamp circuit. The inverter receives the first signal and outputs a first reverse signal, wherein the first reverse signal is reverse with respect to the first signal and is transmitted between the first system voltage and the first ground voltage. A first input terminal of the voltage converter receives the first reverse signal. A second input terminal of the voltage converter receives the first signal. An output terminal of the voltage converter outputs the second signal. A first terminal of the first ESD clamp circuit is coupled to the second system voltage. A second terminal of the first ESD clamp circuit is coupled to the first input terminal of the voltage converter. A first terminal of the second ESD clamp circuit is coupled to the second system voltage. A second terminal of the second ESD clamp circuit is coupled to the second input terminal of the voltage converter.

According to another embodiment of the present invention, a ESD preventing-able level shifter for receiving a first signal and outputting a second signal with a level corresponding to a level of the first signal is provided. The first signal is transmitted between a first system voltage and a first ground voltage, and the second signal is transmitted between a second system voltage and a second ground voltage. The level shifter comprises an inverter, a voltage converter and ESD clamp circuit. The inverter receives the first signal and outputs a first reverse signal, wherein the first reverse signal is reverse to the first signal and transmitted between the first system voltage and the first ground voltage. A first input terminal of the voltage converter receives the first reverse signal. A second input terminal of the voltage converter receives the first signal. An output terminal of the voltage converter outputs the second signal. A first terminal of the ESD clamp circuit is coupled to the second system voltage. A second terminal of the ESD clamp circuit is coupled to the first ground voltage.

According to the exemplary ESD preventing-able level shifters of the present invention, the ESD clamp circuit comprises, for example, an N-type transistor. A drain of the N-type transistor is coupled to a first input terminal of the voltage converter. The gate, the source and the bulk of the N-type transistor are coupled to the second ground voltage. The ESD clamp circuit may comprise, for example, a diode. A cathode of the diode is coupled to the first input terminal of the voltage converter, and an anode of the diode is coupled to the second ground voltage.

By using the ESD clamp circuit, the present invention provides a current route for releasing ESD currents flowing between sets of the power terminals so as to reduce the damage to the internal circuits, such as level shifter, of the integrated circuit.

The above and other features of the present invention will be better understood from the following detailed description of the preferred embodiments of the invention that is provided in communication with the accompanying drawings.

### BRIEF DESCRIPTION OF THE DRAWINGS

FIG. 1A is a partial circuit block diagram of a prior art mixed-voltage integrated circuit.

FIG. 1B is a drawing showing the ESD paths of the level shifter 120 shown in FIG. 1A.

FIG. 1C is a drawing showing another ESD path of the level shifter 120 shown in FIG. 1A.

FIG. 2A is a schematic drawing showing a level shifter according to an embodiment of the present invention.

FIG. 2B is a schematic drawing showing a level shifter according to another embodiment of the present invention.

FIG. 3A is a schematic drawing showing a level shifter according to another embodiment of the present invention.

FIG. 3B is a schematic drawing showing a level shifter according to another embodiment of the present invention.

FIG. 4A is a schematic drawing showing a level shifter according to another embodiment of the present invention.

FIG. 4B is a schematic drawing showing a level shifter according to another embodiment of the present invention.

FIG. 5A is a schematic drawing showing a level shifter according to another embodiment of the present invention.

FIG. 5B is a schematic drawing showing a level shifter according to another embodiment of the present invention.

FIG. 6A is a schematic drawing showing a level shifter according to another embodiment of the present invention.

FIG. 6B is a schematic drawing showing a level shifter according to another embodiment of the present invention.

FIG. 7A is a schematic drawing showing a level shifter according to another embodiment of the present invention.

FIG. 7B is a schematic drawing showing a level shifter according to another embodiment of the present invention.

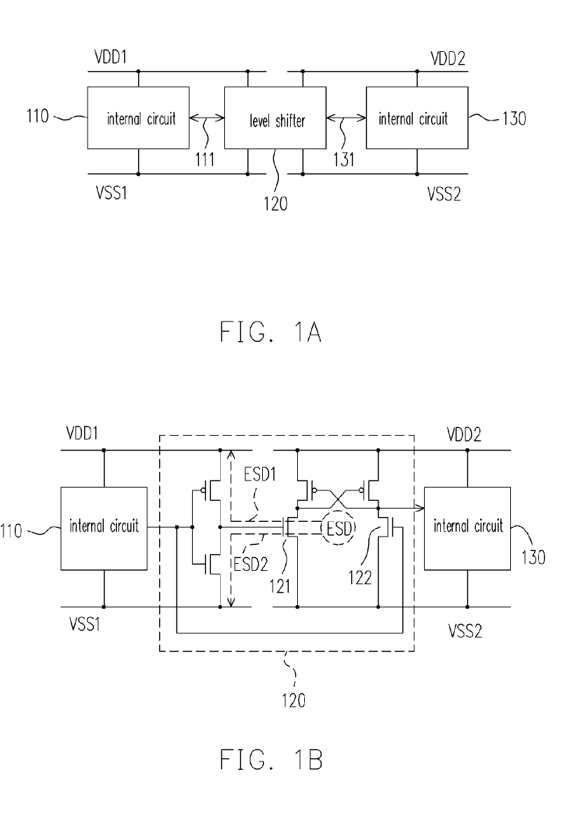

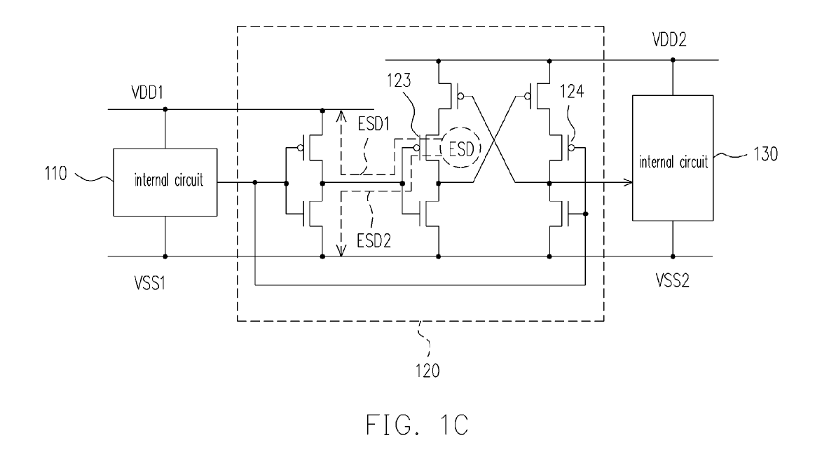

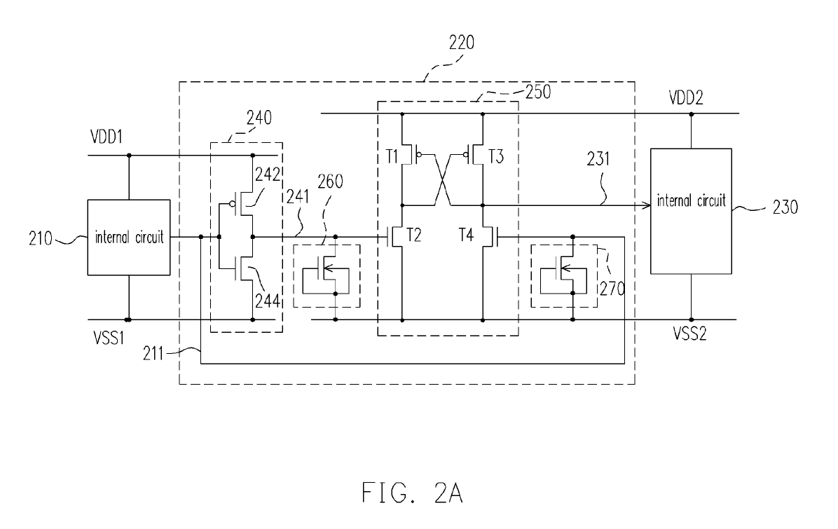

### DESCRIPTION OF EMBODIMENTS

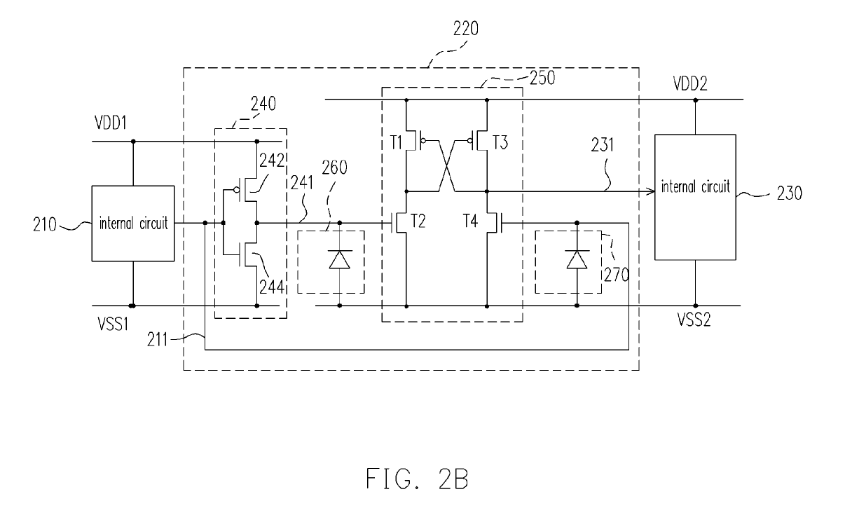

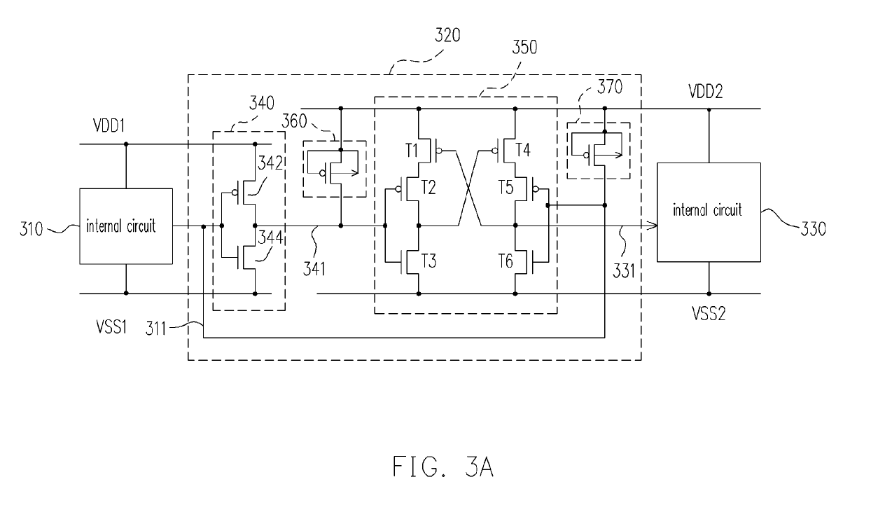

FIG. 2A is a schematic drawing showing a level shifter according to an embodiment of the present invention. Referring to FIG. 2A, the level shifter 220 receives the first signal 211 output from the internal circuit 210 of the integrated circuit. The level shifter 220 outputs a second signal 231 with a level corresponding to the level of the first signal 211, which is received by the internal circuit 230 of the integrated circuit. The first signal 211 is transmitted between the first system voltage VDD1, e.g. 3.3 V, and the first ground voltage VSS1, e.g. 0 V. The second signal 231 is transmitted between the second system voltage VDD2, e.g. 12 V, and the second ground voltage VSS2, e.g. 0 V.

In this embodiment, the level shifter 220 comprises an inverter 240, a voltage converter 250, a first electrostatic discharge (ESD) clamp circuit 260 and a second ESD clamp circuit 270. The inverter 240 receives the first signal 211 and outputs a first reverse signal 241. The first reverse signal 241 is reverse to the first signal 211. The first reverse signal 241 is transmitted between the first system voltage VDD1 and the first ground voltage VSS1.

The inverter 240 comprises, for example, a P-type transistor 242 and an N-type transistor 244. The source of the transistor 242 is coupled to the first system voltage VDD1. The gate of the transistor 242 receives the first signal 211. The drain of the transistor 242 outputs the first reverse signal 241. The gate of the transistor 244 receives the first signal 211. The drain of the transistor 244 is coupled to the drain of the transistor 242. The source of the transistor 244 is coupled to the first ground voltage VSS1.

The first input terminal of the voltage converter 250 receives the first reverse signal 241. The second input terminal of the voltage converter 250 receives the first signal 211. The output terminal of the voltage converter 250 outputs the second signal 231. The voltage converter 250 comprises, for example, the P-type transistors T1 and T3, and the N-type transistors T2 and T4.

The first source/drain, for example, a first source hereafter, of the first transistor T1 is coupled to the second system voltage VDD2. The gate of the second transistor T2 receives the reverse signal 241. The first source/drain, for example, a drain hereafter, of the second transistor T2 is coupled to the second source/drain, for example, a drain hereafter, of the first transistor T1. The second source/drain, for example, a source hereafter, of the second transistor T2 is coupled to the second ground voltage VSS2. The first source/drain, for example, a source hereafter, of the third transistor T3 is coupled to the second system voltage VDD2. The second source/drain, for example, a drain hereafter, of the third transistor T3 is coupled to the gate of the first transistor T1. The gate of the third transistor T3 is coupled to the drain of the first transistor T1. The gate of the fourth transistor T4 receives the first signal 211. The first source/drain, for example, a drain hereafter, of the fourth transistor T4 is coupled to the drain of the third transistor T3. The second source/drain, for example, a source hereafter, of the fourth transistor T4 is coupled to the second ground voltage VSS2. The signal on the drain of the fourth transistor T4 is the second signal 231.

The first terminal of the first ESD clamp circuit 260 is coupled to the first input terminal of the voltage converter 250. The second terminal of the first ESD clamp circuit 260 is coupled to the second ground voltage VSS2. The first terminal of the second ESD clamp circuit 270 is coupled to the second input terminal of the voltage converter 250. The second terminal of the second ESD clamp circuit 270 is coupled to the second ground voltage VSS2.

In this embodiment, the first ESD clamp circuit 260 comprises, for example, an N-type transistor. The drain of the N-type transistor is coupled to the first input terminal of the voltage converter 250. The gate, the source and the bulk of the N-type transistor are coupled to the second ground voltage VSS2. One of ordinary skill in the art will understand that the first ESD clamp circuit 260 may comprise a diode. FIG. 2B is a schematic drawing showing a level shifter according to an another embodiment of the present invention. Referring to FIG. 2B, a diode is used in the first ESD clamp circuit 260. The cathode of the diode is coupled to the first input terminal of the voltage converter 250. The anode of the diode is coupled to the second ground voltage VSS2. In this embodiment, the second clamp circuit 270 is similar to the first clamp circuit 260. Detailed descriptions are not repeated.

When ESD occurs at the terminal of the second ground voltage VSS2, and because the first system voltage VDD1 is grounded, the ESD current will flow from the second ground voltage VSS2 to the first system voltage VDD1 through the first ESD clamp circuit 260 and the transistor 242. If the terminal of the first ground voltage VSS1 is grounded, the ESD current flows from the second ground voltage VSS2 to the first ground circuit VSS1 through the first ESD clamp circuit 260 and the transistor 244. Accordingly, the damage to the level shifter 220 can be reduced.

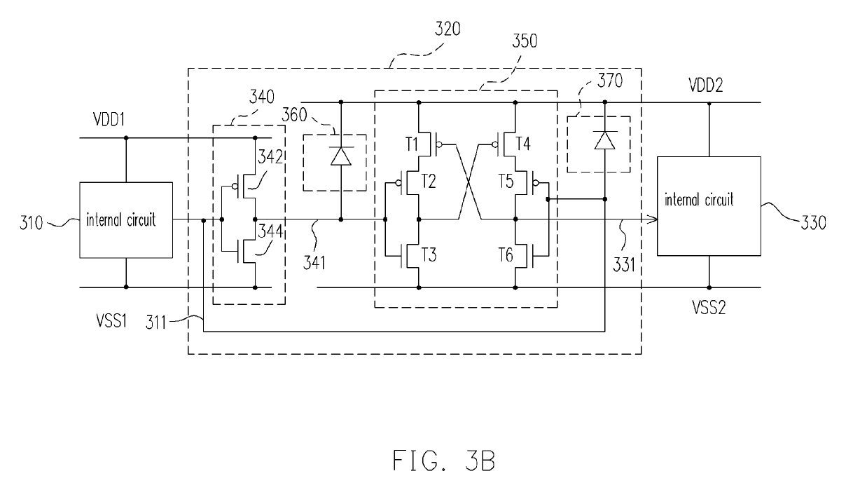

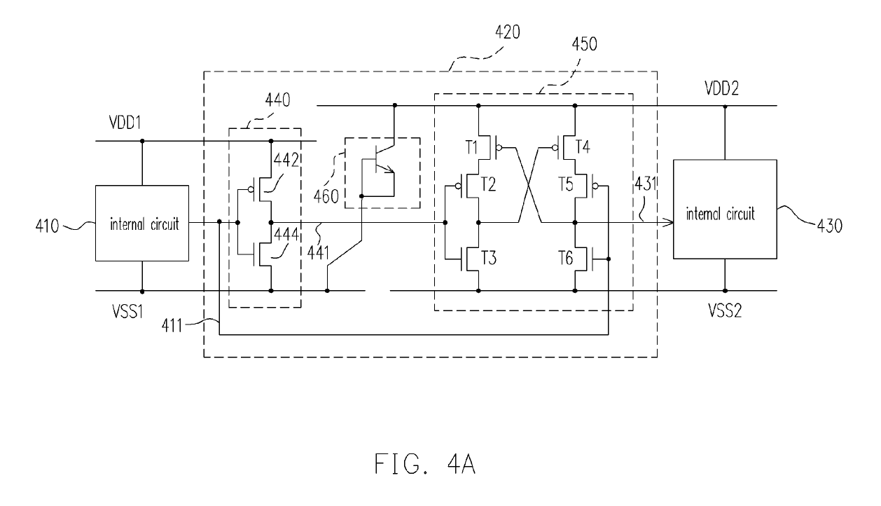

Following are the descriptions of another embodiment of the present invention. FIG. 3A is a schematic drawing showing a level shifter according to another embodiment of the present invention. Referring to FIG. 3A, the level shifter 320 receives the first signal 311 outputted from the internal circuit 310 of the integrated circuit. The level shifter 320 outputs a second signal 331 with a level corresponding to the level of the first signal 311, which is received by the internal circuit 330 of the integrated circuit. The first signal 311 is transmitted between the first system voltage VDD1, e.g. 3.3 V, and the first ground voltage VSS1, e.g. 0 V. The second signal 331 is transmitted between the second system voltage VDD2, e.g. 12 V, and the second ground voltage VSS2, e.g. 0 V. The level shifter 320 comprises an inverter 340, a voltage converter 350, a first electrostatic discharge (ESD) clamp circuit 360 and a second ESD clamp circuit 370.

The inverter 340 receives a first signal 311 and outputs a first reverse signal 341. The first reverse signal 341 is reverse with respect to the first signal 311. The first reverse signal 341 is transmitted between the first system voltage VDD1 and the first ground voltage VSS1. In this embodiment, the inverter 340 comprises, for example, a P-type transistor 342 and an N-type transistor 344. The source of the transistor 342 is coupled to the first system voltage VDD1. The gate of the transistor 342 receives the first signal 311. The drain of the transistor 342 outputs the first reverse signal 341. The gate of the transistor 344 receives the first signal 311. The drain of the transistor 344 is coupled to the drain of the transistor 342. The source of the transistor 344 is coupled to the first ground voltage VSS1.

The first input terminal of the voltage converter 350 receives the first reverse signal 341. The second input terminal of the voltage converter 350 receives the first signal 311. The output terminal of the voltage converter 350 outputs the second signal 331. The first terminal of the first ESD clamp circuit 360 is coupled to the second system voltage VDD2. The second terminal of the first ESD clamp circuit 360 is coupled to the first input terminal of the voltage converter 350. The first terminal of the second ESD clamp circuit 370 is coupled to the second system voltage VDD2. The second terminal of the second ESD clamp circuit 370 is coupled to the second input terminal of the voltage converter 350.

The voltage converter 350 comprises, for example, the P-type transistors T1, T2, T4 and T5, and the N-type transistors T3 and T6. The first source/drain, for example, a source hereafter, of the first transistor T1 is coupled to the second system voltage VDD2. The gate of the second transistor T2 receives the reverse signal 341. The first source/drain, for example, a source hereafter, of the second transistor T2 is coupled to the second source/drain, for example, a drain thereafter, of the first transistor T1. The gate of the third transistor T3 receives the first reverse signal 341. The first source/drain, for example, a drain thereafter, of the third transistor T3 is coupled to the second source/drain, for example, a drain hereafter, of the second transistor T2. The second source/drain, for example, a source hereafter, of the third transistor T3 is coupled to the second ground voltage VSS2. The first source/drain, for example, a source hereafter, of the fourth transistor T4 is coupled to the second system voltage VDD2. The gate of the fourth transistor T4 is coupled to the drain of the second transistor T2. The gate of the fifth transistor T5 receives the first signal 311. The first source/drain, for example, a source, of the fifth transistor T5 is coupled to the second source/drain, for example, a drain, of the fourth transistor T4. The second source/drain, for example, a drain, of the fifth transistor T5 is coupled to the gate of the transistor T1. The gate of the sixth transistor T6 receives the first signal 311. The first source/drain, for example, a drain, of the sixth transistor T6 is coupled to the drain of the fifth transistor T5. The second source/drain, for example, a source, of the sixth transistor T6 is coupled to the second ground voltage VSS2. The signal on the drain of the sixth transistor T6 is the second signal 331.

In this embodiment, the first ESD clamp circuit 360 comprises, for example, a P-type transistor. The drain of the P-type transistor is coupled to the first input terminal of the voltage converter 350. The gate, the source and the bulk of the P-type transistor are coupled to the second system voltage VDD2. One of ordinary skill in the art will understand that the first ESD clamp circuit 360 may comprise a diode. FIG. 3B is a schematic drawing showing a level shifter according to another embodiment of the present invention. Referring to FIG. 3B, a diode is used in the first ESD clamp circuit 360. The anode of the diode is coupled to the first input terminal of the voltage converter 350. The cathode of the diode is coupled to the second system voltage VDD2. In this embodiment, the second ESD clamp circuit 370 is similar to the first ESD clamp circuit 360. Detailed descriptions are not repeated.

When ESD occurs at the terminal of the second system voltage VDD2 and the first system voltage VDD1 is grounded, the ESD current will flow from the second system voltage VDD2 to the first system voltage VDD1 through the first ESD clamp circuit 360 and the transistor 342. If the terminal of the first ground voltage VSS1 is grounded, the ESD current will flow from the second system voltage VDD2 to the first ground circuit VSS1 through the first ESD clamp circuit 360 and the transistor 344. Accordingly, damage to the level shifter 320 can be reduced.

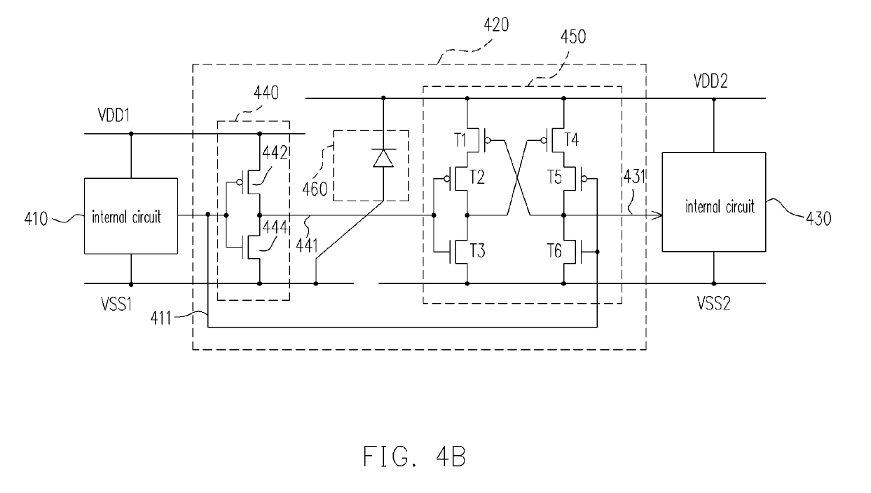

Following are the descriptions of another embodiment of the present invention. FIG. 4A is a schematic drawing showing another level shifter according to an embodiment of the present invention. Referring to FIG. 4A, the level shifter 420 receives the first signal 411 outputted from the internal circuit 410 of the integrated circuit. The level shifter 420 outputs a second signal 431 with a level corresponding to the level of the first signal 411, which is received by the internal circuit 430 of the integrated circuit. The first signal 411 is transmitted between the first system voltage VDD1, e.g. 3.3 V, and the first ground voltage VSS1, e.g. 0 V. The second signal 431 is transmitted between the second system voltage VDD2, e.g. 12 V, and the second ground voltage VSS2, e.g. 0 V.

In this embodiment, the level shifter 420 comprises an inverter 440, a voltage converter 450 and an electrostatic discharge (ESD) clamp circuit 460. The inverter 440 receives the first signal 411 and outputs a first reverse signal 441. The first reverse signal 441 is reverse with respect to the first signal 411. The first reverse signal 441 is transmitted between the first system voltage VDD1 and the first ground voltage VSS1.

The voltage converter 450 and the inverter 440 are similar to the voltage converter 350 and the inverter 340 shown in FIG. 3A, respectively above. Detailed descriptions are not repeated.

The first terminal of the ESD clamp circuit 460 is coupled to the second system voltage VDD2, and the second terminal of the ESD clamp circuit 460 is coupled to the first ground voltage VSS1. In this embodiment, the ESD clamp circuit 460 comprises, for example, a transistor. The collector of the transistor is coupled to the second system voltage VDD2. The emitter and base of the transistor is coupled to the first ground voltage VSS1. One of ordinary skill in the art will understand that the ESD clamp circuit 460 may comprise a diode. FIG. 4B is a schematic drawing showing another level shifter according to an embodiment of the present invention. Referring to FIG. 4B, a diode is used in the ESD clamp circuit 460. The anode of the diode is coupled to the first ground voltage VSS1. The cathode of the diode is coupled to the second system voltage VDD2.

When ESD occurs at the terminal of the second system voltage VDD2, and because the first ground voltage VSS1 is grounded, the ESD current will flow from the second system voltage VDD2 to the first ground voltage VSS1 through the ESD clamp circuit 460. Accordingly, damage to the level shifter 420 can be reduced.

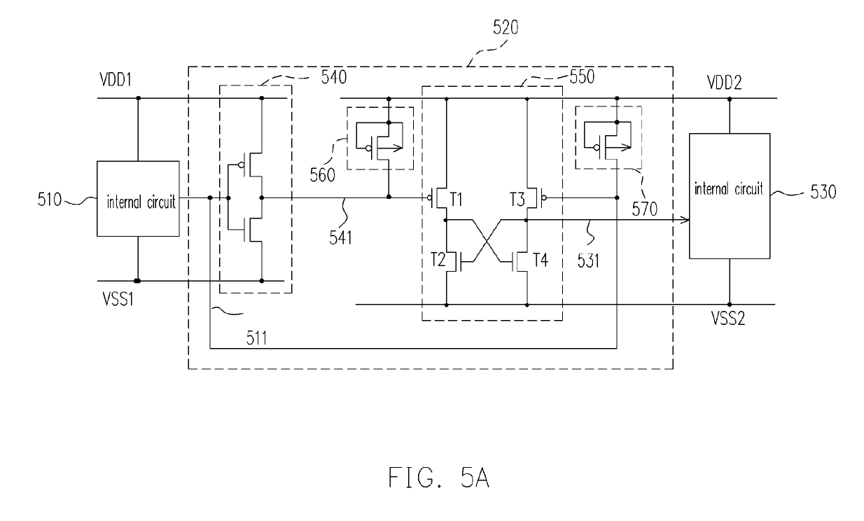

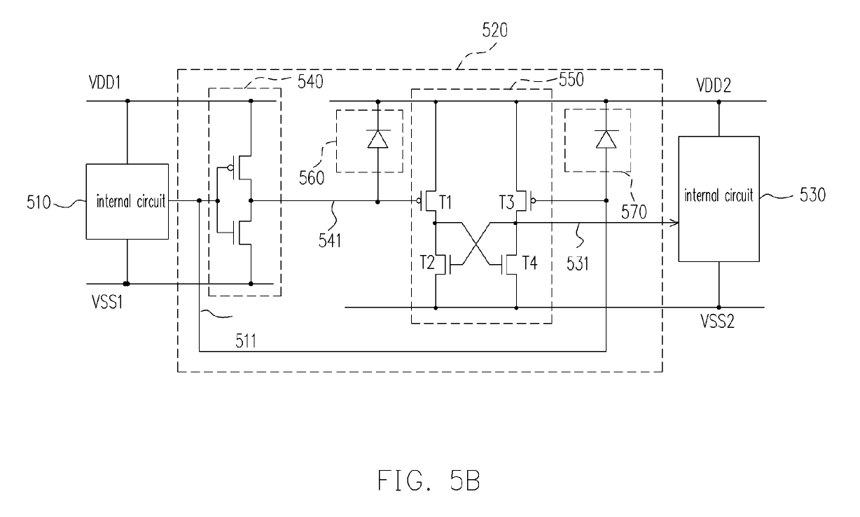

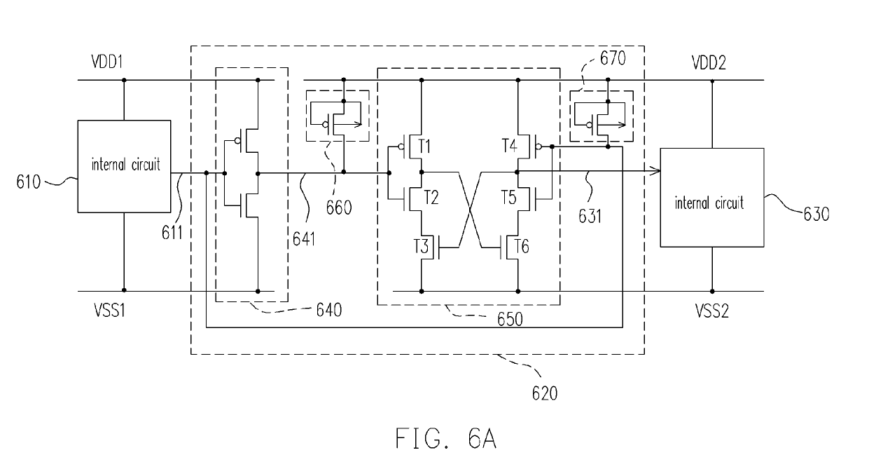

Following are the descriptions of another embodiment present invention. FIG. 5A is a schematic drawing showing a level shifter according to another embodiment of the present invention. Referring to FIG. 5A, the level shifter 520 receives the first signal 511 outputted from the internal circuit 510 of the integrated circuit. The level shifter 520 outputs a second signal 531 with a level corresponding to the level of the first signal 511, which is received by the internal circuit 530 of the integrated circuit. The first signal 511 is transmitted between the first system voltage VDD1, e.g. 12 V, and the first ground voltage VSS1, e.g. 0 V. The second signal 531 is transmitted between the second system voltage VDD2, e.g. 3.3 V, and the second ground voltage VSS2, e.g. 0 V.

In this embodiment, the level shifter 520 comprises an inverter 540, a voltage converter 550 and electrostatic discharge (ESD) clamp circuits 560 and 570. The inverter 540 receives the first signal 511 and outputs a first reverse signal 541. The first reverse signal 541 is reverse with respect to the first signal 511. The first reverse signal 541 is transmitted between the first system voltage VDD1 and the first ground voltage VSS1.

In this embodiment, the inverter 540 is similar to those described above. Detailed descriptions are not repeated.

In this embodiment, the voltage converter 550 comprises, for example, the P-type transistors T1 and T3, and the N-type transistors T2 and T4. The first source/drain, named as a source thereafter, of the transistor T1 is coupled to the second system voltage VDD2. The gate of the transistor T1 receives a reverse signal 541. The first source/drain, for example, a drain hereafter, of the transistor T2 is coupled to the second source/drain, for example, a drain hereafter, of the transistor T1. The second source/drain, for example, a source hereafter, of the transistor T2 is coupled to the second ground voltage VSS2. The first source/drain, for example, a source hereafter, of the transistor T3 is coupled to the second system voltage VDD2. The second source/drain, for example, a drain hereafter, of the transistor T3 is coupled to the gate of the transistor T2. The gate of the transistor T3 receives the signal 511. The gate of the transistor T4 is coupled to the drain of the transistor T1. The first source/drain, for example, a drain hereafter, of the transistor T4 is coupled to the drain of the transistor T3. The second source/drain, for example, a source hereafter, of the transistor T4 is coupled to the second ground voltage VSS2. The signal on the drain of the transistor T4 is the second signal 531.

The first terminal of the first ESD clamp circuit 560 is coupled to the second system voltage VDD2. The second terminal of the first ESD clamp circuit 560 is coupled to gate of the first transistor T1. In this embodiment, the first ESD clamp circuit 560 comprises, for example, a P-type transistor. The drain of the P-type transistor is coupled to the first input terminal of the voltage converter 550, i.e. the gate of the first transistor T1. The gate, the source and the bulk of the P-type transistor are coupled to the second system voltage VDD2. One of ordinary skill in the art will understand that the first ESD clamp circuit 560 may comprise a diode. FIG. 5B is a schematic drawing showing a level shifter according to another embodiment of the present invention. Referring to FIG. 5B, a diode is used in the first ESD clamp circuit 560. The cathode of the diode is coupled to the second system voltage VDD2. The anode of the diode is coupled to the first input terminal of the voltage converter 550, i.e. the gate of the transistor T1.

In this embodiment, the ESD clamp circuit 570 is similar to the first ESD clamp circuit. Detailed descriptions are not repeated.

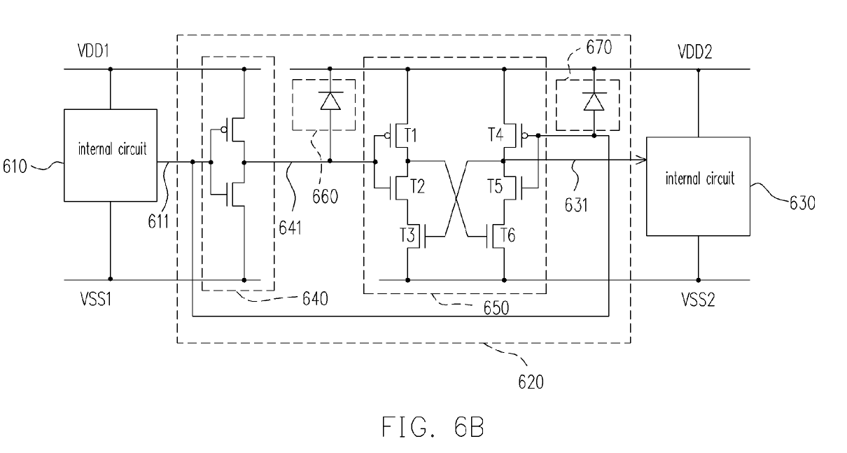

FIG. 6A is a schematic drawing showing a level shifter according to another embodiment of the present invention. Referring to FIG. 6A, the level shifter 620 receives the first signal 611 outputted from the internal circuit 610 of the integrated circuit. The level shifter 620 outputs a second signal 631 with a level corresponding to the level of the first signal 611, which is received by the internal circuit 630 of the integrated circuit. The first signal 611 is transmitted between the first system voltage VDD1, e.g. 12 V, and the first ground voltage VSS1, e.g. 0 V. The second signal 631 is transmitted between the second system voltage VDD2, e.g. 3.3 V, and the second ground voltage VSS2, e.g. 0 V.

In this embodiment, the level shifter 620 comprises an inverter 640, a voltage converter 650 and electrostatic discharge (ESD) clamp circuits 660 and 670. The inverter 640 receives the first signal 611 and outputs a first reverse signal 641. The first reverse signal 641 is reverse with respect to the first signal 611. The first reverse signal 641 is transmitted between the first system voltage VDD1 and the first ground voltage VSS1.

In this embodiment, the inverter 640 is similar to those described above. Detailed descriptions are not repeated.

The voltage converter 650 comprises, for example, the P-type transistors T1 and T4, and the N-type transistors T2, T3, T5 and T6. The gate of the first transistor T1 receives the reverse signal 641. The first source/drain, for example, a source hereafter, of the transistor T1 is coupled to the second system voltage VDD2. The gate of the transistor T2 is coupled to the gate of the transistor T1. The first source/drain, for example, a drain hereafter, of the transistor T2 is coupled to the second source/drain, for example, a drain hereafter, of the transistor T1. The first source/drain, for example, a drain hereafter, of the transistor T3 is coupled to the second source/drain, for example, a source thereafter, of the transistor T2. The second source/drain, for example, a source thereafter, of the transistor T3 is coupled to the second ground voltage VSS2. The first source/drain, for example, a source thereafter, of the transistor T4 is coupled to the second system voltage VDD2. The second source/drain, for example, a drain hereafter, of the transistor T4 is coupled to the gate of the transistor T3. The gate of the transistor T4 receives the first signal 611. The gate of the transistor T5 is coupled to the gate of the transistor T4. The first source/drain, for example, a drain, of the transistor T5 is coupled to the drain of the transistor T4. The gate of the transistor T6 is coupled to the drain of the transistor T1. The first source/drain, for example, a drain, of the transistor T6 is coupled to the source of the transistor T5. The second source/drain, for example, a source, of the transistor T6 is coupled to the second ground voltage VSS2. The signal on the drain of the transistor T6 is the second signal 631.

The first terminal of the ESD clamp circuit 660 is coupled to the second system voltage VDD2, and the second terminal of the ESD clamp circuit 660 is coupled to the gates of the first and the second transistors T1 and T2, respectively. In this embodiment, the first ESD clamp circuit 660 comprises, for example, a P-type transistor. The drain of the P-type transistor is coupled to the first input terminal of the voltage converter 650, i.e. the gates of the first and the second transistors T1 and T2. The gate, the source and the bulk of the P-type transistor are coupled to the second system voltage VDD2. One of ordinary skill in the art will understand that the first ESD clamp circuit 660 may comprise a diode. FIG. 6B is a schematic drawing showing another level shifter according to an embodiment of the present invention. Referring to FIG. 6B, a diode is used in the ESD clamp circuit 660. The anode of the diode is coupled to the first input terminal of the voltage converter 650. The cathode of the diode is coupled to the second system voltage VDD2.

In this embodiment, the second ESD clamp circuit 670 is similar to the ESD clamp circuit 660. Detailed descriptions are not repeated.

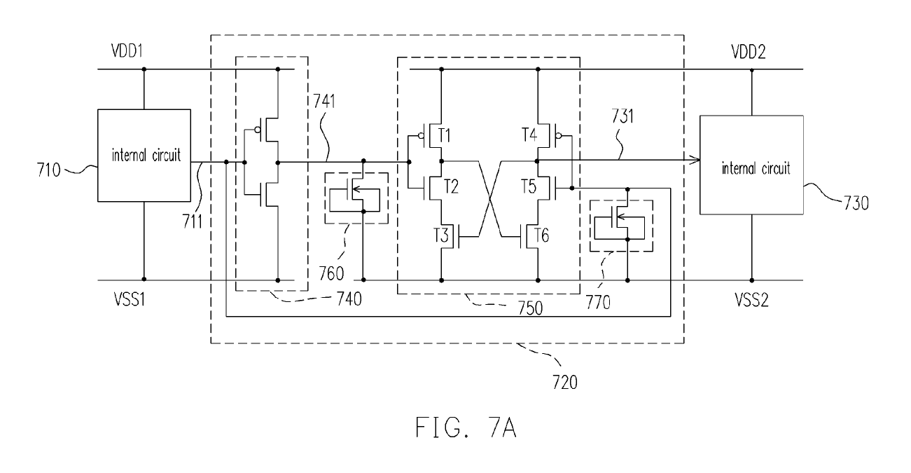

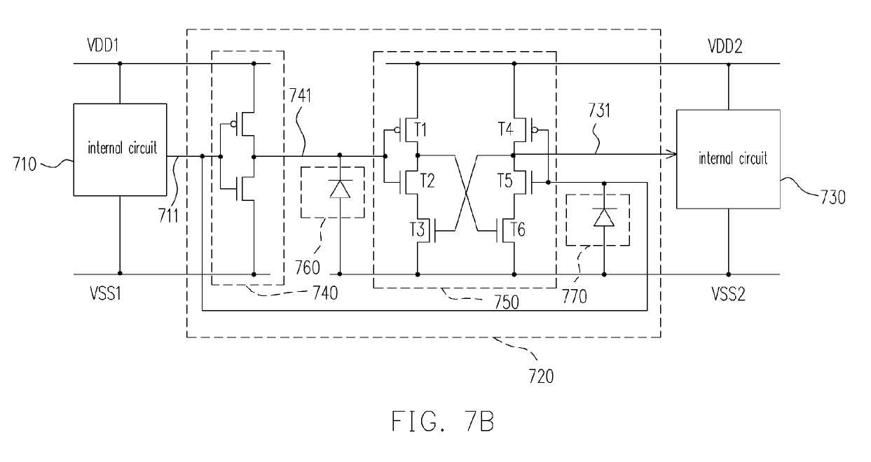

FIG. 7A is a schematic drawing showing a level shifter according to another embodiment of the present invention. Referring to FIG. 7A, the level shifter 720 receives the first signal 711 outputted from the internal circuit 710 of the integrated circuit. The level shifter 720 outputs a second signal 731 with a level corresponding to the level of the first signal 711, which is received by the internal circuit 730 of the integrated circuit. The first signal 711 is transmitted between the first system voltage VDD1, e.g. 12 V, and the first ground voltage VSS1, e.g. 0 V. The second signal 731 is transmitted between the second system voltage VDD2, e.g. 3.3 V, and the second ground voltage VSS2, e.g. 0 V.

In this embodiment, the level shifter 720 comprises an inverter 740, a voltage converter 750 and electrostatic discharge (ESD) clamp circuits 760 and 770. The inverter 740 receives the first signal 711 and outputs a first reverse signal 741. The first reverse signal 741 is reverse to the first signal 711. The first reverse signal 741 is transmitted between the first system voltage VDD1 and the first ground voltage VSS1.

The voltage converter 750 and the inverter 740 are similar to the voltage converter 650 and the inverter 640 shown in FIG. 6A, respectively. Detailed descriptions are not repeated.

The first terminal of the ESD clamp circuit 760 is coupled to gates of the first and the second transistors T1 and T2, respectively, and the second terminal of the ESD clamp circuit 760 is coupled to the second ground voltage VSS2. In this embodiment, the first ESD clamp circuit 760 comprises, for example, an N-type transistor. The drain of the N-type transistor is coupled to the first input terminal of the voltage converter 750, i.e. the gates of the first and the second transistors T1 and T2. The gate, the source and the bulk of the N-type transistor are coupled to the second ground voltage VSS2. One of ordinary skill in the art will understand that the first ESD clamp circuit 760 may comprise a diode. FIG. 7B is a schematic drawing showing a level shifter according to another embodiment of the present invention. Referring to FIG. 7B, a diode is used in the ESD clamp circuit 760. The cathode of the diode is coupled to the first input terminal of the voltage converter 750. The anode of the diode is coupled to the second ground voltage VSS2.

In this embodiment, the second ESD clamp circuit 770 is similar to the ESD clamp circuit 760. Detailed descriptions are not repeated.

It can be noted that the voltage converter 450 shown in FIGS. 4A and 4B can be replaced by any other voltage converter, such as the voltage converters 250, 550 and 650 shown in FIGS. 2A, 5A and 6A, respectively.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A electrostatic discharge (ESD) preventing-able level shifter, for receiving a first signal and outputting a second signal with a level corresponding to a level of the first signal, the first signal being transmitted between a first system voltage and a first ground voltage, and the second signal being transmitted between a second system voltage and a second ground voltage, the level shifter comprising:
an inverter, for receiving the first signal and outputting a first reverse signal, wherein the first reverse signal is reverse with respect to the first signal and is transmitted between the first system voltage and a first ground voltage;
a voltage converter, wherein a first input terminal of the voltage converter is adapted for receiving the first reverse signal, a second input terminal of the voltage converter is adapted for receiving the first signal and an output terminal of the voltage converter is adapted for outputting the second signal;
a first ESD clamp circuit, wherein a first terminal of the first ESD clamp circuit is coupled to the first input terminal of the voltage converter and a second terminal of the first ESD clamp circuit is coupled to the second ground voltage; and
a second ESD clamp circuit, wherein a first terminal of the second ESD clamp circuit is coupled to the second input terminal of the voltage converter and a second terminal of the second ESD clamp circuit is coupled to the second ground voltage.

2. The ESD preventing-able level shifter of claim 1, wherein the first ESD clamp circuit comprises an N-type transistor, wherein a drain of the N-type transistor is coupled to the first input terminal of the voltage converter, and wherein a gate, a source and a bulk of the N-type transistor are coupled to the second ground voltage.

3. The ESD preventing-able level shifter of claim 1, wherein the first ESD clamp circuit comprises a diode, wherein a cathode of the diode is coupled to the first input terminal of the voltage converter and an anode of the diode is coupled to the second ground voltage.

4. The ESD preventing-able level shifter of claim 1, wherein the inverter comprises:
a P-type transistor, wherein a source of the P-type transistor is coupled to the first system voltage, a gate of the P-type transistor is adapted for receiving the first signal, a drain of the P-type transistor is adapted for outputting the first reverse signal; and
an N-type transistor, wherein a gate of the N-type transistor is adapted for receiving the first signal, a drain of the N-type transistor is coupled to the drain of the P-type transistor, a source of the N-type transistor is coupled to the first ground voltage.

5. The ESD preventing-able level shifter of claim 1, wherein the voltage converter comprises:
a first transistor, wherein a first drain/source of the first transistor is coupled to the second system voltage;
a second transistor, wherein a gate of the second transistor is adapted for receiving the first reverse signal, a first source/drain of the second transistor is coupled to a second source/drain of the first transistor and a second source/drain terminal of the second transistor is coupled to the second ground voltage;
a third transistor, wherein a first source/drain of the third transistor is coupled to the second system voltage, a second source/drain of the third transistor is coupled to the gate of the first transistor and a gate of the third transistor is coupled to the second source/drain of the first transistor; and
a fourth transistor, wherein a gate of the fourth transistor is adapted for receiving a first signal, a first source/drain of the fourth transistor is coupled to the second source/drain of the third transistor and a second source/drain of the fourth transistor is coupled to the second ground voltage, and wherein a signal of the first source/drain of the fourth transistor is the second signal.

6. The ESD preventing-able level shifter of claim 5, wherein the first and third transistors are P-type transistors and the second and fourth transistors are N-type transistors.

7. The ESD preventing-able level shifter of claim 1, wherein the voltage converter comprises:
a first transistor, wherein a gate of the first transistor is adapted for receiving the first reverse signal and a first source/drain of the first transistor is coupled to the second system voltage;
a second transistor, wherein a gate of the second transistor is coupled to the gate of the first transistor and a first source/drain of the second transistor is coupled to a second source/drain of the first transistor;
a third transistor, wherein a first source/drain of the third transistor is coupled to a second source/drain of the second transistor and a second source/drain of the third transistor is coupled to the second ground voltage;
a fourth transistor, wherein a first source/drain of the fourth transistor is coupled to the second system voltage, a second source/drain of the fourth transistor is coupled to a gate of the third transistor and a gate of the fourth transistor is adapted for receiving the first signal;
a fifth transistor, wherein a gate of the fifth transistor is coupled to the gate of the fourth transistor and a first source/drain of the fifth transistor is coupled to the second source/drain of the fourth transistor; and
a sixth transistor, wherein a gate of the sixth transistor is coupled to the second source/drain of the first transistor, a first source/drain of the sixth transistor is coupled to a second source/drain of the fifth transistor and a second source/drain of the sixth transistor is coupled to the second ground voltage, and wherein a signal of the first source/drain of the fifth transistor is the second signal.

8. The ESD preventing-able level shifter of claim 7, wherein the first and fourth transistors are P-type transistors and the second, third, fifth and sixth transistors are N-type transistors.

9. A electrostatic discharge (ESD) preventing-able level shifter, for receiving a first signal and outputting a second signal with a level corresponding to a level of the first signal, the first signal being transmitted between a first system voltage and a first ground voltage, and the second signal being transmitted between a second system voltage and a second ground voltage, the level shifter comprising:
an inverter, for receiving the first signal and outputting a first reverse signal, wherein the first reverse signal is reverse with respect to the first signal and is transmitted between the first system voltage and a first ground voltage;
a voltage converter, wherein a first input terminal of the voltage converter is adapted for receiving the first reverse signal, a second input terminal of the voltage converter is adapted for receiving the first signal and an output terminal of the voltage converter is adapted for outputting the second signal;
a first ESD clamp circuit, wherein a first terminal of the first ESD clamp circuit is coupled to the second system voltage and a second terminal of the first ESD clamp circuit is coupled to the first input terminal of the voltage converter; and
a second ESD clamp circuit, wherein a first terminal of the second ESD clamp circuit is coupled to the second system voltage and a second terminal of the second ESD clamp circuit is coupled to the second input terminal of the voltage converter.

10. The ESD preventing-able level shifter of claim 9, wherein the first ESD clamp circuit comprises an P-type transistor, a drain of the P-type transistor is coupled to the first input terminal of the voltage converter; and a gate, a source and a bulk of the P-type transistor are coupled to the second system voltage.

11. The ESD preventing-able level shifter of claim 9, wherein the first ESD clamp circuit comprises a diode, an anode of the diode is coupled to the first input terminal of the voltage converter and a cathode of the diode is coupled to the second system voltage.

12. The ESD preventing-able level shifter of claim 9, wherein the inverter comprises:
a P-type transistor, wherein a source of the P-type transistor is coupled to the first system voltage, a gate of the P-type transistor is adapted for receiving the first signal and a drain of the P-type transistor is adapted for outputting the first reverse signal; and
an N-type transistor, wherein a gate of the N-type transistor is adapted for receiving the first signal, a drain of the N-type transistor is coupled to the drain of the P-type transistor and a source of the N-type transistor is coupled to the first ground voltage.

13. The ESD preventing-able level shifter of claim 9, wherein the voltage converter comprises:
a first transistor, wherein a first source/drain of the first transistor is coupled to the second system voltage;
a second transistor, wherein a gate of the second transistor is adapted for receiving the first reverse signal and a first source/drain of the second transistor is coupled to a second source/drain of the first transistor;
a third transistor, wherein a gate of the third transistor is adapted for receiving the first reverse signal, a first source/drain of the third transistor is coupled to a second source/drain of the second transistor and a second source/drain of the third transistor is coupled to the second ground voltage;
a fourth transistor, wherein a first source/drain of the fourth transistor is coupled to the second system voltage, a gate of the fourth transistor is coupled to the second source/drain of the second transistor;
a fifth transistor, wherein a gate of the fifth transistor is adapted for receiving the first signal, a first source/drain of the fifth transistor is coupled to the second source/drain of the fourth transistor and a second source/drain of the fifth transistor is coupled to a gate of the first transistor; and
a sixth transistor, wherein a gate of the sixth transistor is adapted for receiving the first signal, a first source/drain of the sixth transistor is coupled to the second source/drain of the fifth transistor and a second source/drain of the sixth transistor is coupled to the second ground voltage, and wherein a signal of the first source/drain of the sixth transistor is the second signal.

14. The ESD preventing-able level shifter of claim 13, wherein the first, second, fourth and fifth transistors are P-type transistors, and third and sixth transistors are N-type transistors.

15. The ESD preventing-able level shifter of claim 9, wherein the voltage converter comprises:
a first transistor, wherein a first drain/source of the first transistor is coupled to the second system voltage and a gate of the first transistor is adapted for receiving the first reverse signal;
a second transistor, wherein a first source/drain of the second transistor is coupled to a second source/drain of the first transistor and a second source/drain terminal of the second transistor is coupled to the second ground voltage;
a third transistor, wherein a first source/drain of the third transistor is coupled to the second system voltage, a second source/drain voltage is coupled to the gate of the second transistor and a gate of the third transistor is adapted for receiving the first signal; and
a fourth transistor, wherein a gate of the fourth transistor is coupled to the second source/drain of the first transistor, a first source/drain of the fourth transistor is coupled to the second source/drain of the third transistor and a second source/drain of the fourth transistor is coupled to the second ground voltage, and wherein a signal of the first source/drain of the fourth transistor is the second signal.

16. The ESD preventing-able level shifter of claim 15, wherein the first and third transistors are P-type transistors, and the second and fourth transistors are N-type transistors.

17. The ESD preventing-able level shifter of claim 9, wherein the voltage converter comprises:
a first transistor, wherein a gate of the first transistor is adapted for receiving the first reverse signal and a first source/drain of the first transistor is coupled to the second system voltage;
a second transistor, wherein a gate of the second transistor is coupled to the gate of the first transistor and a first source/drain of the second transistor is coupled to a second source/drain of the first transistor;
a third transistor, wherein a first source/drain of the third transistor is coupled to a second source/drain of the second transistor and a second source/drain of the third transistor is coupled to the second ground voltage;
a fourth transistor, wherein a first source/drain of the fourth transistor is coupled to the second system voltage, a second source/drain of the fourth transistor is coupled to a gate of the third transistor and a gate of the fourth transistor is adapted for receiving the first signal;
a fifth transistor, wherein a gate of the fifth transistor is coupled to the gate of the fourth transistor and a first source/drain of the fifth transistor is coupled to the second source/drain of the fourth transistor; and
a sixth transistor, wherein a gate of the sixth transistor is coupled to the second source/drain of the first transistor, a first source/drain of the sixth transistor is coupled to a second source/drain of the fifth transistor and a second source/drain of the sixth transistor is coupled to the second ground voltage, and wherein a signal of the first source/drain of the fifth transistor is the second signal.

18. The ESD preventing-able level shifter of claim 17, wherein the first and fourth transistors are P-type transistors, and the second, third, fifth and sixth transistors are N-type transistors.

19. A electrostatic discharge (ESD) preventing-ablelevel shifter, for receiving a first signal and outputting a second signal with a level corresponding to a level of the first signal, the first signal being transmitted between a first system voltage and a first ground voltage and the second signal being transmitted between a second system voltage and a second ground voltage, the level shifter comprising:
an inverter, for receiving the first signal and outputting a first reverse signal, wherein the first reverse signal is reverse with respect to the first signal and is transmitted between the first system voltage and a first ground voltage;
a voltage converter, wherein a first input terminal of the voltage converter is adapted for receiving the first reverse signal, a second input terminal of the voltage converter is adapted for receiving the first signal and an output terminal of the voltage converter is adapted for outputting the second signal; and
an ESD clamp circuit, wherein a first terminal of the ESD clamp circuit is coupled to the second system voltage and a second terminal of the ESD clamp circuit is coupled to the first ground voltage.

20. The ESD preventing-able level shifter of claim 19, wherein the first ESD clamp circuit comprises a transistor, and wherein a collector of the transistor is coupled to the second system voltage, and an emitter and a base of the transistor are coupled to the first ground voltage.

21. The ESD preventing-able level shifter of claim 19, wherein the ESD clamp circuit comprises diode, wherein an anode of the diode is coupled to the first ground voltage and a cathode of the diode is coupled to the second system voltage.

22. The ESD preventing-able level shifter of claim 19, wherein the inverter comprises:
a P-type transistor, wherein a source of the P-type transistor is coupled to the first system voltage, a gate of the P-type transistor is adapted for receiving the first signal and a drain of the P-type transistor is adapted for outputting the first reverse signal; and
an N-type transistor, wherein a gate of the N-type transistor is adapted for receiving the first signal, a drain of the N-type transistor is coupled to the drain of the P-type transistor and a source of the N-type transistor is coupled to the first ground voltage.

23. The ESD preventing-able level shifter of claim 9, wherein the voltage converter comprises:
a first transistor, wherein a first source/drain of the first transistor is coupled to the second system voltage;
a second transistor, wherein a gate of the second transistor is adapted for receiving the first reverse signal and a first source/drain of the second transistor is coupled to a second source/drain of the first transistor;
a third transistor, wherein a gate of the third transistor is adapted for receiving the first reverse signal, a first source/drain of the third transistor is coupled to a second source/drain of the second transistor and a second source/drain of the third transistor is coupled to the second ground voltage;
a fourth transistor, wherein a first source/drain of the fourth transistor is coupled to the second system voltage and a gate of the fourth transistor is coupled to the second source/drain of the second transistor;
a fifth transistor, wherein a gate of the fifth transistor is adapted for receiving the first signal, a first source/drain of the fifth transistor is coupled to the second source/drain of the fourth transistor and a second source/drain of the fifth transistor is coupled to a gate of the first transistor; and
a sixth transistor, wherein a gate of the sixth transistor is adapted for receiving the first signal, a first source/drain of the sixth transistor is coupled to the second source/drain of the fifth transistor and a second source/drain of the sixth transistor is coupled to the second ground voltage, and wherein a signal of the first source/drain of the sixth transistor is the second signal.

24. The ESD preventing-able level shifter of claim 23, wherein the first, second, fourth and fifth transistors are P-type transistors and the third and sixth transistors are N-type transistors.
